(19) United States
(12) Patent Application Publication
(10) Pub. No.: US 2024/0176664 A1
(43) Pub. Date: May 30, 2024

(54) ARTIFICIAL INTELLIGENCE APPLICATION PROVISION METHOD AND APPARATUS FOR SUPPORTING EDGE COMPUTING FOR CYBER-PHYSICAL SYSTEMS

(71) Applicant: ELECTRONICS AND TELECOMMUNICATIONS RESEARCH INSTITUTE, Daejeon (KR)

(72) Inventor: Young-Joo KIM, Daejeon (KR)

(73) Assignee: ELECTRONICS AND TELECOMMUNICATIONS RESEARCH INSTITUTE, Daejeon (KR)

(21) Appl. No.: 18/347,352

(22) Filed: Jul. 5, 2023

(30) Foreign Application Priority Data
Nov. 29, 2022 (KR) 10-2022-0162995

(51) Int. Cl. G06F 9/50

(52) U.S. Cl. CPC G06F 9/5027

(57) ABSTRACT

Disclosed herein are an artificial intelligence application provision method and apparatus for supporting Edge computing for Cyber-Physical Systems (EdgeCPS). The artificial intelligence application provision method includes receiving an artificial intelligence application and service specification, obtaining artificial intelligence-related information allocated from an artificial intelligence information sharing database based on the artificial intelligence application and service specification, creating a pipeline specification corresponding to the artificial intelligence application and service specification, and allocating resources corresponding to respective pipelines using the pipeline specification.

### CROSS REFERENCE TO RELATED APPLICATION

This application claims the benefit of Korean Patent Application No. 10-2022-0162995, filed Nov. 29, 2022, which is hereby incorporated by reference in its entirety into this application.

### BACKGROUND OF THE INVENTION

### 1. Technical Field

The present disclosure relates to a platform for providing an artificial intelligence service in a cloud computing environment or an embedded computing environment.

### 2. Description of the Related Art

Artificial intelligence application services have shown good performance in object detection, object tracking, situation prediction, etc. Because various sensors and large-scale data used for such artificial intelligence services generally need to be processed within a short period of time, high-performance computing environments are required. Recently, even in a low-performance computing environment, continuous research into various learning methods, lightening methods, etc. has been conducted so as to support artificial intelligence services. In various computing environments, artificial intelligence services have changed from standalone applications into network-based applications. The reason for this is that the scale of network infrastructure has increased and the scale of a target to which services are to be provided has also increased. Due thereto, it is not easy to guarantee an optimal executing environment depending on the situation of the system, and characteristics and change speeds of respective services provided in a situation in which an IT environment is becoming larger and complicated are different from each other, thus making it difficult to modify and deploy the services.

As a method for solving this difficulty, a scheme for gradually solving problems while sharing information such as a dataset or a solution with an online platform such as Kaggle is adopted. Further, on Kubernetes in which resources can be efficiently executed and managed, a platform such as Kubeflow provides an integrated management environment for an Artificial Intelligence (AI) application, and provides a visualization function such as a pipeline. However, Kaggle provides a large amount of data necessary for creating AI-related applications, but it adopts the optimal results by taking into consideration only model performance without considering data and devices. Because of this, there are many cases where, when a user executes the corresponding AI application on an arbitrary system using the adopted optimal results, performance desired by the user is not exhibited. Further, although a strong pipeline function such as Kubeflow is provided, various requirements such as hardware requirements, user requirements, and performance requirements are not taken into consideration, thus making it difficult to provide an optimal AP application in various execution environments.

Edge computing for Cyber-Physical System (EdgeCPS) platform technology refers to technology for satisfying service requirements desired by the user by augmenting the performance or functions of resources, thus intelligently controlling the real world. Performance augmentation from the standpoint of hardware refers to allocation of cores, storage space, memory, devices, etc. in conformity with the purpose of artificial intelligence applications. Also, function augmentation from the standpoint of software refers to technology for changing a non-AI application into an AI application using AI elements such as machine running, Convolutional Neural Network (CNN), or Recurrent Neural Network (RNN), or providing an optimized AI application using optimization, individualization, clustering, decentralization, etc. so as to provide optimized artificial intelligence applications.

Therefore, there is urgently required technology for supporting component-based AI application configuration so that the AI application is executable on such an EdgeCPS platform.

### PRIOR ART DOCUMENTS

### Patent Documents

(Patent Document 1) Korean Patent Application Publication No. 10-2021-0122431 (Title of disclosure: Machining System for Artificial Intelligence Processing on Service Platform)

### SUMMARY OF THE INVENTION

Accordingly, the present disclosure has been made keeping in mind the above problems occurring in the prior art, and an object of the present disclosure is to provide an optimal execution environment for an application service in an artificial intelligence application software specification platform in an EdgeCPS environment.

Another object of the present disclosure is to provide a function that allows a program developer or a user to easily develop an artificial intelligence application in an EdgeCPS environment.

In accordance with an aspect of the present disclosure to accomplish the above objects, there is provided an artificial intelligence application provision method for supporting Edge computing for Cyber-Physical Systems (EdgeCPS), including receiving an artificial intelligence application and service specification, obtaining artificial intelligence-related information allocated from an artificial intelligence information sharing database based on the artificial intelligence application and service specification, creating a pipeline specification corresponding to the artificial intelligence application and service specification, and allocating resources corresponding to respective pipelines using the pipeline specification.

Allocating the resources corresponding to respective pipelines may include allocating the resources using a deployment specification created based on a query converter.

The query converter may create a query for extracting the artificial intelligence-related information from the artificial intelligence information sharing database based on the artificial intelligence application and service specification.

The deployment specification may include detailed specifications including global information, basic information, system information, and application information, and the global information includes information applied to remaining detailed specifications.

The artificial intelligence application provision method may further include, when the resources allocated to the pipelines are insufficient, transmitting a request to allocate additional resources to an artificial intelligence resource information system, and rebuilding the pipelines based on the additionally allocated resources.

The artificial intelligence application and service specification may include information about an artificial intelligence application category, an artificial intelligence application deployment way, an artificial intelligence application type, an artificial intelligence application inference method, an artificial intelligence application inference type, or an artificial intelligence application inference target.

The pipeline specification may include input/output of the artificial intelligence application, preprocessed information, a number of parameters, or characteristic information of the artificial intelligence application.

In accordance with another aspect of the present disclosure to accomplish the above objects, there is provided an artificial intelligence application provision apparatus for supporting Edge computing for Cyber-Physical Systems (EdgeCPS), including memory configured to store at least one program, and a processor configured to execute the program, wherein the program includes instructions for performing receiving an artificial intelligence application and service specification, obtaining artificial intelligence-related information allocated from an artificial intelligence information sharing database based on the artificial intelligence application and service specification, creating a pipeline specification corresponding to the artificial intelligence application and service specification, and allocating resources corresponding to respective pipelines using the pipeline specification.

Allocating the resources corresponding to respective pipelines may include allocating the resources using a deployment specification created based on a query converter.

The query converter may create a query for extracting the artificial intelligence-related information from the artificial intelligence information sharing database based on the artificial intelligence application and service specification.

The deployment specification may include detailed specifications including global information, basic information, system information, and application information, and the global information includes information applied to remaining detailed specifications.

The program may further include instructions for performing, when the resources allocated to the pipelines are insufficient, transmitting a request to allocate additional resources to an artificial intelligence resource information system, and rebuilding the pipelines based on the additionally allocated resources.

The artificial intelligence application and service specification may include information about an artificial intelligence application category, an artificial intelligence application deployment way, an artificial intelligence application type, an artificial intelligence application inference method, an artificial intelligence application inference type, or an artificial intelligence application inference target.

The pipeline specification may include input/output of the artificial intelligence application, preprocessed information, a number of parameters, or characteristic information of the artificial intelligence application.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart illustrating an artificial intelligence application provision method for supporting EdgeCPS according to an embodiment of the present disclosure;

FIG. 2 is a diagram illustrating an example in which an artificial intelligence (AI) application service specification is deployed and operated in an actual environment in an EdgeCPS environment;

FIG. 3 illustrates a specification forming an AI application SW specification platform based on information sharing technology for supporting EdgeCPS;

FIG. 4 illustrates a detailed specification flow of EdgeCPS-supporting AI application and service specification;

FIG. 5 illustrates a specification flow for supporting an AI application;

FIG. 6 is a conceptual diagram illustrating a specification created in a method according to an embodiment of the present disclosure;

FIG. 7 illustrates an example of an AI specification in a method according to an embodiment of the present disclosure;

FIG. 8 illustrates an example of a pipeline specification in a method according to an embodiment of the present disclosure;

FIG. 9 is a block diagram illustrating an example of the structure of a query converter;

FIG. 10 is a table illustrating examples of a query requested from a knowledge sharing system;

FIG. 11 is a diagram conceptually illustrating a deployment specification in a method according to an embodiment of the present disclosure;

FIG. 12 illustrates an example of a deployment specification in a method according to an embodiment of the present disclosure;

FIG. 13 is a diagram conceptually illustrating a system for providing an artificial intelligence application according to an embodiment of the present disclosure; and

FIG. 14 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Hereinafter, embodiments of the present disclosure will be described in detail with reference to the accompanying drawings. In the following description of the present disclosure, the same reference numerals are used to designate the same or similar elements throughout the drawings and repeated descriptions of the same components will be omitted.

The present disclosure relates to a method and a system for a software (SW) specification platform in which an artificial intelligence application can be easily created and deployed in order to provide an optimal execution environment in an EdgeCPS environment.

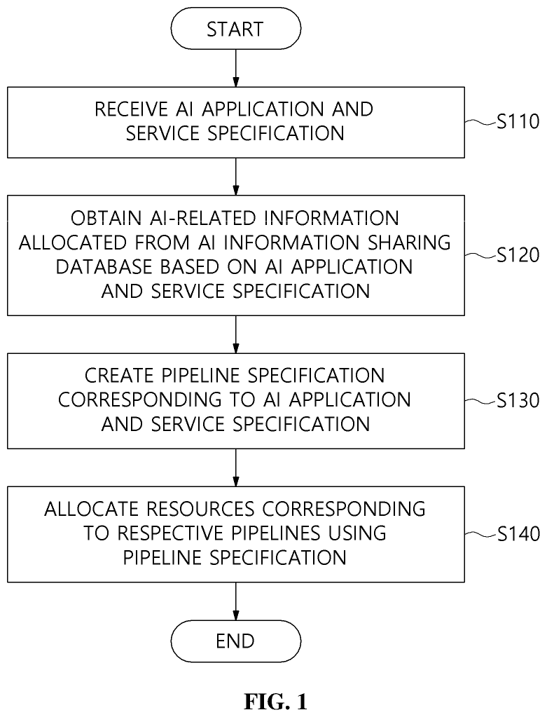

FIG. 1 is a flowchart illustrating an artificial intelligence application provision method for supporting EdgeCPS according to an embodiment of the present disclosure.

The artificial intelligence application provision method for supporting EdgeCPS according to an embodiment of the present disclosure may be performed by an artificial intelligence application provision apparatus such as a computing device or a server.

Referring to FIG. 1, the method according to the embodiment of the present disclosure includes step S110 of receiving an artificial intelligence (AI) application and service specification, step S120 of obtaining AI-related information allocated from an AI information sharing database (DB) based on the AI application and service specification, step S130 of creating a pipeline specification corresponding to the AI application and service specification, and step S140 of allocating resources corresponding to respective pipelines using the pipeline specification.

Here, step S140 of allocating the resources corresponding to respective pipelines may include the step of allocating resources using a deployment specification created based on a query converter.

Here, the query converter may create a query for extracting AI-related information from the AI information sharing DB based on the AI application and service specification.

Here, the deployment specification may include a detailed specification including global information, basic information, system information, and application information, and the global information may include information applied to the remaining detailed specifications.

Here, the method may further include the step of, when resources allocated to the pipelines are insufficient, transmitting a request to allocate additional resources to an AI resource information system and the step of rebuilding the pipelines based on the additional allocated resources.

Here, the AI application and service specification may include information about an AI application category, an AI application deployment way, an AI application type, an AI application inference method, an AI application inference type, or an AI application inference target.

Here, the pipeline specification may include the input/output of the AI application, preprocessed information, the number of parameters, or characteristic information of the AI application.

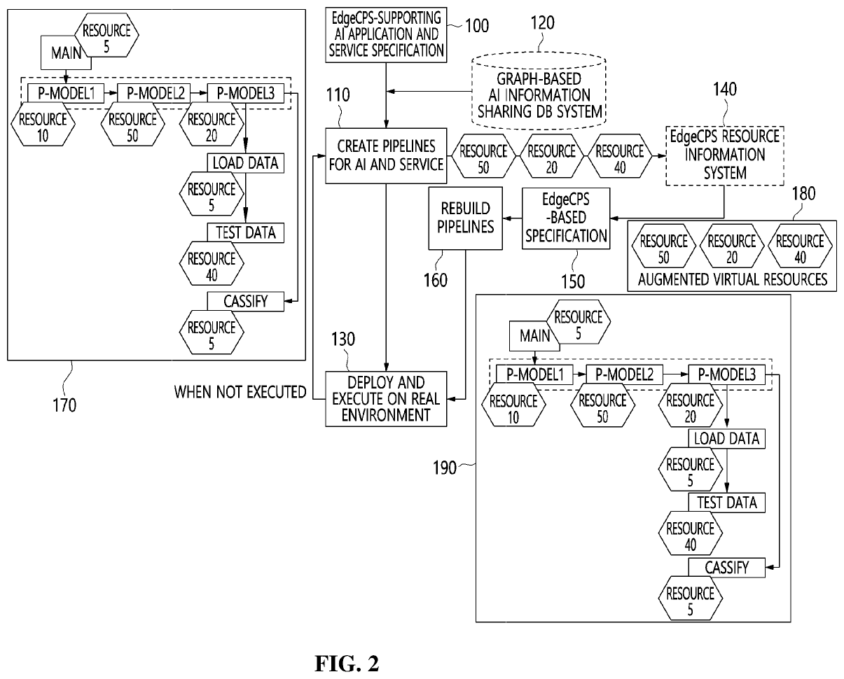

FIG. 2 is a diagram illustrating an example in which an artificial intelligence application service specification is deployed and operated in an actual environment in an EdgeCPS environment.

Referring to FIG. 2, the method according to the embodiment creates an EdgeCPS-supporting Artificial Intelligence (AI) application and service specification 100, and obtains AI-related information allocated from a graph-based AI information sharing DB system 120. The AI information sharing DB system 120 stores learning/training data, a trained model, an inference algorithm, hardware information, code information, etc. For example, when a face recognition inference application is created, a face learning model that is a previously trained model is supported by the information sharing DB system.

Next, pipelines for an application and service are created (110) using the supported information. The pipelines are deployed to and executed in the actual environment (130) using the pipeline specification created in this way. Then, respective pipelines are executed using predefined resources 170. In this state, when the AI application and service is not executed due to the insufficiency of the resources in pipelines “P-Model-2”, “P-Model-3”, and “TestData”, the corresponding information is fed back into a pipeline creation module, and the pipeline creation module requests an EdgeCPS resource information system 140 to allocate additional resources for “resource 50”, “resource 20”, and “resource 40”. Augmented virtual resources are allocated from the EdgeCPS resource information system 140 to regenerate an EdgeCPS-based specification 150, and pipelines are rebuilt (160). When the AI application and service is re-executed using the pipelines built in this way, the AI application and service is smoothly executed in the pipelines “P-Model-2”, “P-Model-3”, and “TestData”, unlike the previous case, and thus the AI application and service is normally executed (190). In the present disclosure, details of the graph-based AI information sharing DB system 120 are not handled here.

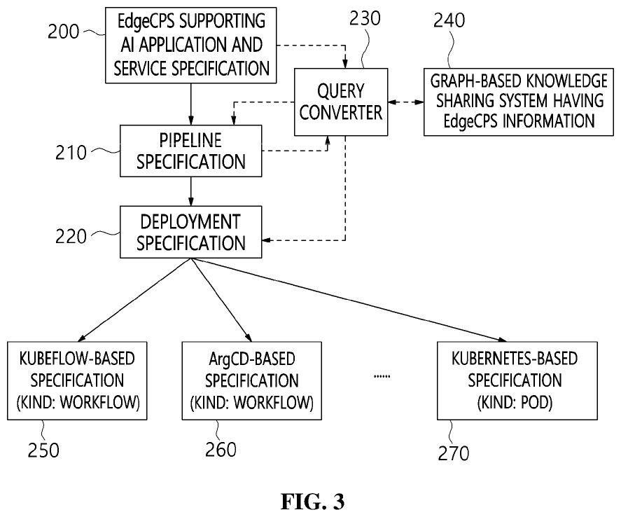

FIG. 3 illustrates specifications forming an AI application SW specification platform based on information sharing technology for supporting EdgeCPS.

Referring to FIG. 3, the AI application SW specification platform includes an EdgeCPS-supporting AI application and service specification 200, a pipeline specification 210, a deployment specification 220, a Kubeflow-based specification 250, an ArgCD-based specification 260, a Kubernetes-based specification 270, etc. In addition, in order to utilize a graph-based knowledge sharing system 240 having EdgeCPS information, a query converter 230 is used.

The query converter 230 may be utilized in the EdgeCPS-supporting AI application and service specification, and may also be utilized in the pipeline specification. That is, the query converter 230 may be an option selected by a user and a developer. Consequently, EdgeCPS-related information may be supported by any one of the EdgeCPS-supporting AI application and service specification 200 and the pipeline specification 210. Because a specification interpreter for interpreting individual specifications may be differently implemented in respective embodiments, the specification interpreter does not fall within the scope of the present disclosure.

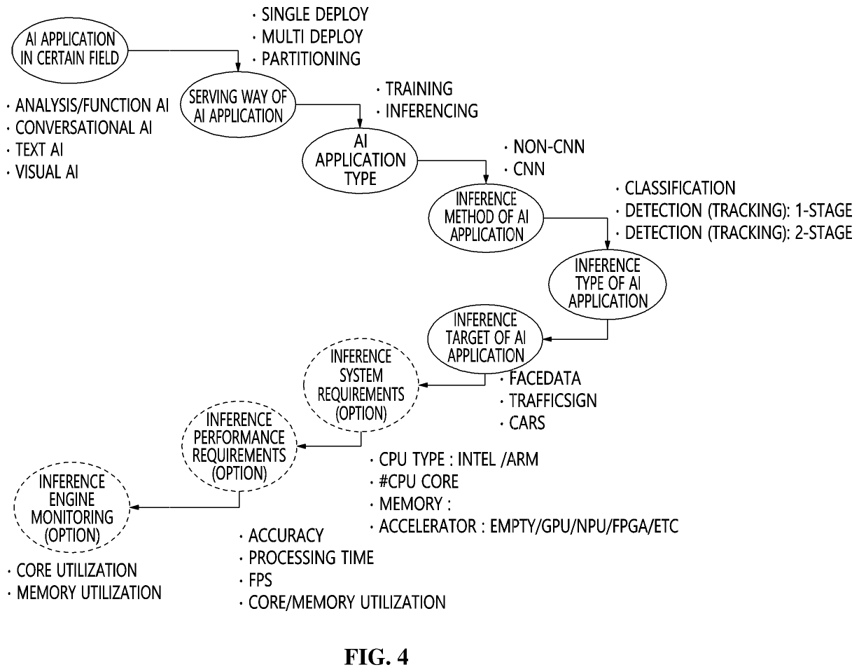

FIG. 4 illustrates a detailed specification flow of an EdgeCPS-supporting AI application and service specification.

Referring to FIG. 4, a detailed specification flow of the EdgeCPS-supporting AI application and service specification 200 is illustrated. The detailed flow of the EdgeCPS-supporting AI application and service specification 200 is composed of a total of nine stages. When a user who will create an AI program selects each artificial intelligence (AI) with reference to properties defined in respective stages, the specification is finally created. In a first stage, one of analysis/function AI, conversational AI, text AI, and visual AI is selected. The analysis/function AI is related to data analysis, data pattern identification, data interpretation, etc., and the conversational AI is related to automatic conversation, chatbot, smart personal secretaries, etc. Further, the text AI is related to text analysis and recognition, speech-to-text conversion, natural language processing, etc., and the visual AI is related to image/video recognition, image/video classification, image/video tracking, etc.

In a second stage, the serving way of the AI application is selected. There are properties such as “Single Deploy”, “Multi Deploy”, and “Partitioning” properties. “Single Deploy” refers to a method for deploying and executing a finally created pipeline-based AI application on one system. “Multi Deploy” refers to a method for deploying and executing a finally created pipeline-based AI application on two or more systems. Further, “Partitioning” refers to a method for partitioning an AI-related pipeline into several segments and executing the segments due to a high computational load.

In a third stage, an AI application type is selected. This is intended to select whether an AI application for learning is to be created or an AI application for inference is to be created. In a fourth stage, an inference way (inference method) for the AI application is selected. The inference method includes a non-CNN-based inference method using OpenCV or the like, and a CNN-based inference method such as VGG, ResNet, or Google.

From the fourth stage, a flow limited to an inference application is illustrated. In the fourth stage, the inference method for the AI application is selected. Although a non-CNN method and a CNN method are present as selection properties, the scope of the present disclosure is not limited thereto. In a fifth stage, an inference type for the AI application is selected. There are selectable properties such as Classification (VGG, ResNet, GoogleNet, Inception, etc.), 1-Stage-based Detection (tracking) (SSD, YOLO, etc.), and 2-Stage-based Detection (tracking) (R-CNN, Fast R-CNN, etc.). In this stage, an AI algorithm is selected. In a sixth stage, an inference target for the AI application is selected. As a selectable property, an inference target supported by the knowledge sharing system of FIG. 3 may be selected. For example, when the knowledge sharing system supports a face recognition-related learning model, a vehicle traffic sign-related learning model, and a vehicle recognition-related learning model, the user may select one of the learning models. Seventh to ninth stages may be options. In details, the options are sequentially configured to describe requirements of a system on which the AI application is running, describe requirements for inference performance of the AI application, and describe whether profiling is to be performed for monitoring of the AI application.

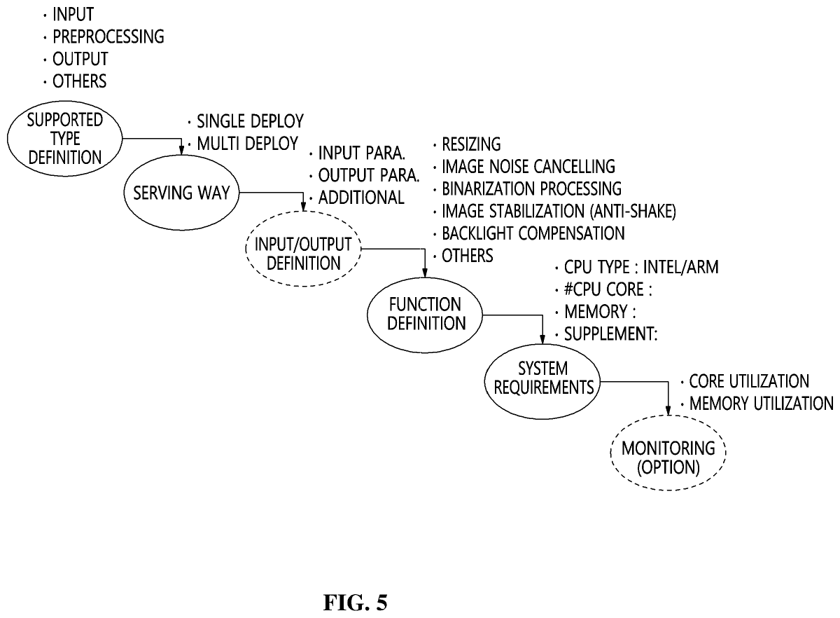

FIG. 5 illustrates a specification flow for supporting an AI application.

Referring to FIG. 5, the specification flow for supporting the AI application is composed of a total of six stages. In a first stage, a supported type is selected. As selectable properties, there are “INPUT”, “PREPROCESSING”, “OUTPUT”, and “OTHERS”. In a second stage, a serving way is selected similar to the first stage of FIG. 5. In a third stage, input and output parameters required for the corresponding function are defined. In a fourth stage, functions are defined. For example, when “PREPROCESSING” is selected, one or more of various functions that can be preprocessed may be selected. In a fifth stage, system requirements to be performed by functions related to the selected supported type are described. In a sixth stage, the performance of functions is profiled.

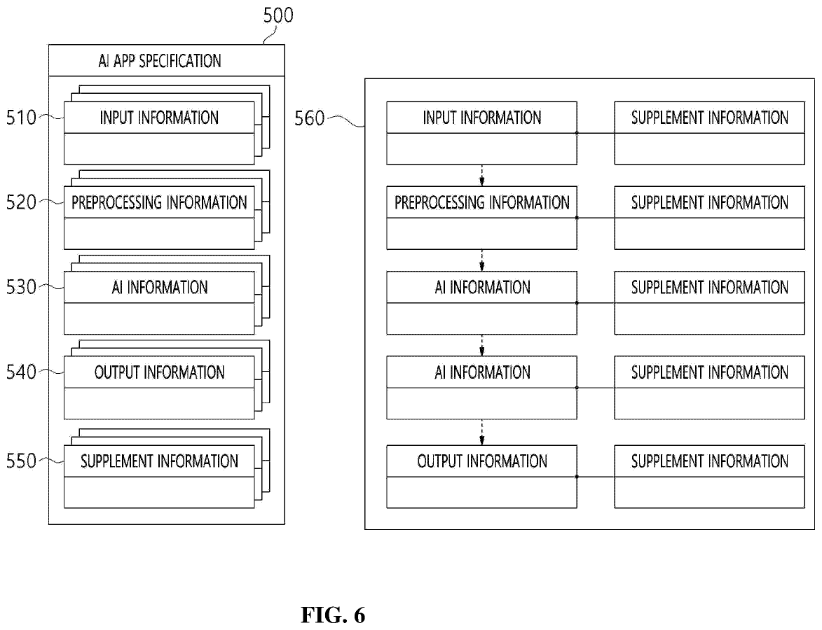

FIG. 6 is a conceptual diagram illustrating a specification created in a method according to an embodiment of the present disclosure.

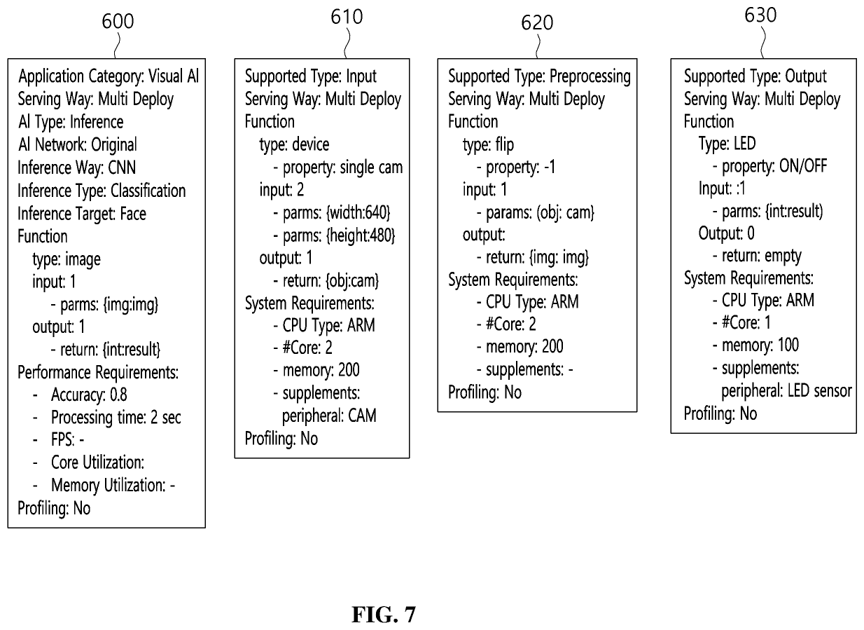

FIG. 7 illustrates an example of an AI specification in a method according to an embodiment of the present disclosure.

Referring to FIG. 6, an AI application service specification 500 may mainly include five detailed specifications 510, 520, 530, 540, and 550. Each detailed specification has one or more specifications, each including a specification 560 in which insufficient portions thereof are supplemented. The detailed specification “Input Information” 510 is a portion corresponding to the section 610 of FIG. 7. The detailed specification “Preprocessing Information” 520 is a portion corresponding to the section 620 of FIG. 7. The detailed specification “AI Information” 530 is a portion corresponding to the section 600 of FIG. 7. The detailed specification “Output Information” 540 is a portion corresponding to the section 630 of FIG. 7. The detailed specification “Supplement Information” 550 is a portion which supplements insufficient portions in the specifications 510 to 540, and which is additionally created when functions other than “INPUT”, “PREPROCESSING”, “AI”, and “OUTPUT” are required.

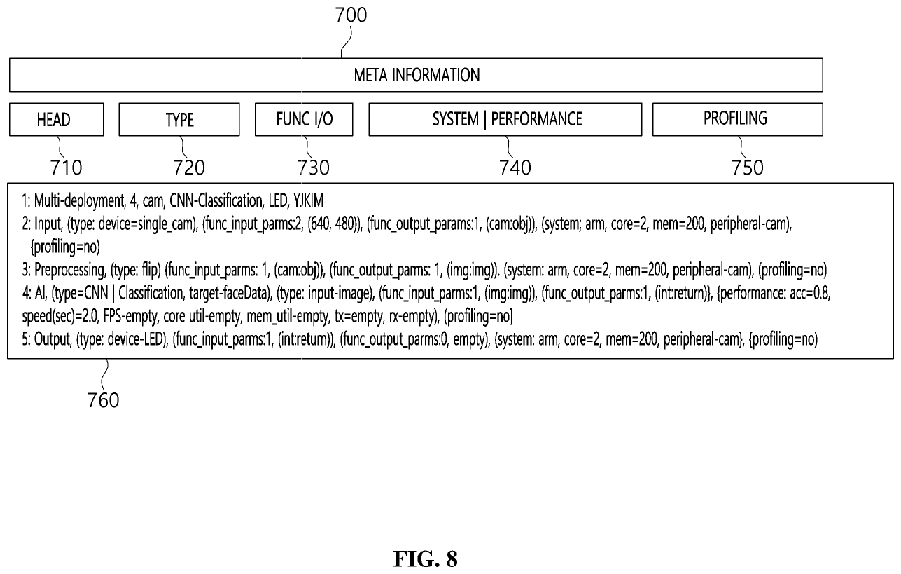

FIG. 8 illustrates an example of a pipeline specification in a method according to an embodiment of the present disclosure.

The pipeline specification of FIG. 8 may be created using the AI specification illustrated in FIG. 7.

An example of the specification illustrated in FIG. 8 may be referred to as pipeline intermediate representation in some cases. In the pipeline specification, “Meta Information” is a portion corresponding to a first line in the section 760 of FIG. 8. In the first line, an application serving way, the number of application configurations, an external input device, program features, an external output device, and a user or a developer are indicated. “Head” 710, “Type” 720, “Func I/O” 730, “System Performance” 740, and “Profiling” 750 are the core portions of the pipeline specification. “Head” represents Input, Preprocessing, AI, and Output. “Type” represents features corresponding to each “Head”. For example, the type of input in a second line in the section 760 indicates that a single camera, which is an external input device, is used. Therefore, {type: device=single_cam} is defined. “Func I/O” defines the number of input/output parameters required for defining the property of each function and the input and output of each function. For example, in a third line in the section 760, it can be seen that the number of input parameters is 1, the value of the input parameter is a camera value, the number of output parameters is 1, and the value of the output parameter is an image. Therefore, {func_input_parms:1, {cam:obj}} and {func_output_parms:1, {img:img}} are defined. “System| Performance” may require system performance according to “Head”, and may require execution performance. For example, “INPUT”, “PREPROCESSING”, and “OUTPUT” require system performance, and “AI” requires execution performance. In a fourth line in the section 760 of FIG. 8, “AI” features are indicated. Therefore, execution performance is defined. Thus, “{performance, acc=0.8, speed (sec)=2.0, FPS=empty, core_util=empty, mem_util=empty, tx=empty, rx=empty}” is defined. Finally, “Profiling” defines whether profiling is supported for each “Head”. When Profiling is set to yes, profiling code is added to executable code or the like.

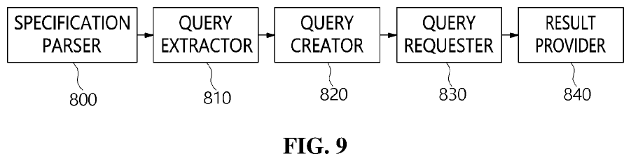

FIG. 9 is a block diagram illustrating an example of the structure of a query converter.

Referring to FIG. 9, the query converter may include a specification parser 800, a query extractor 810, a query creator 820, a query requester 830, and a result provider 840.

The role of the query converter is to analyze the contents of an AI application and service specification or a pipeline specification, create a query to be requested from a knowledge sharing system, and extract information matching the query. The query converter may be used in the stage of the AI application and service specification 200 and the stage of the pipeline specification 210 of FIG. 3. First, in the stage of the AI application and service specification 200, the corresponding information may be extracted from the knowledge sharing system 240 through the query converter, and may be used for the creation of the pipeline specification that is the next stage. Second, in the stage of the pipeline specification, corresponding information may be extracted from the knowledge sharing system 240 through the query converter, and may be used for the creation of a deployment specification that is the next stage. The query converter may be composed of a specification parser, a query extractor, a query creator, a query requester, and a result provider. The knowledge sharing system provides the corresponding source code and the corresponding image (e.g., a Docker image or the like), and provides an AI algorithm conforming to hardware desired by the user or performance desired by the user.

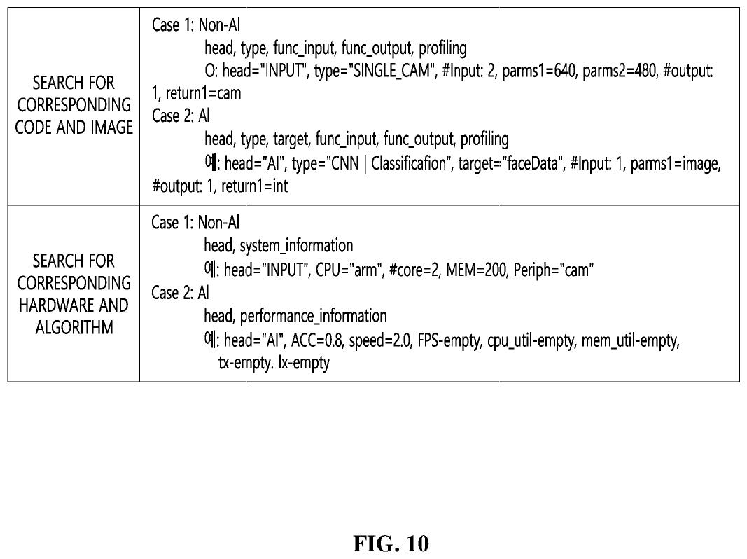

FIG. 10 is a table illustrating examples of a query requested from a knowledge sharing system.

Referring to FIG. 10, queries are separately created in the case of non-AI and the case of AI, and the types of queries are divided into a type used to search for the corresponding code and image and a type used to search for hardware and an algorithm.

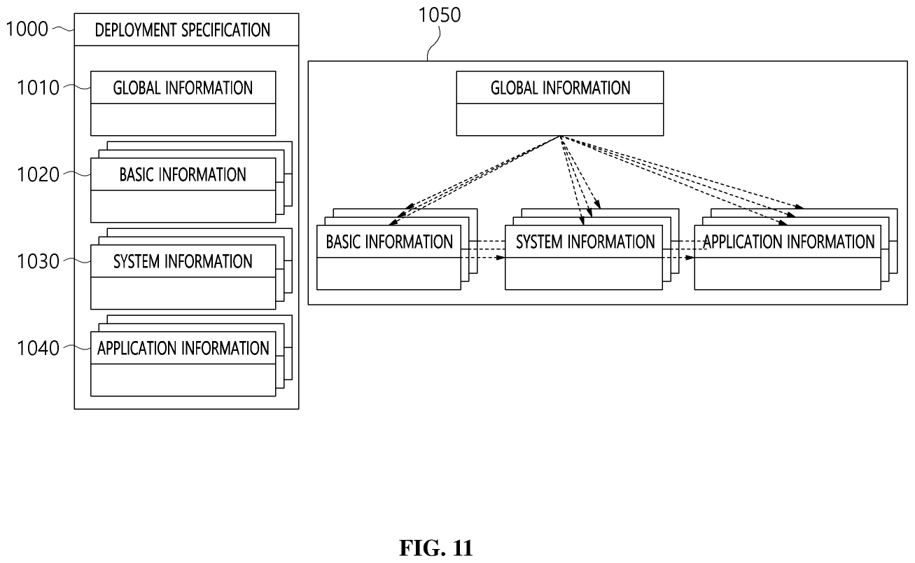

FIG. 11 is a diagram conceptually illustrating a deployment specification in a method according to an embodiment of the present disclosure.

Referring to FIG. 11, methods for the deployment specification may include a method for deploying and executing the deployment specification on a system in the real environment, a method for deploying and executing the deployment specification on a system in a virtual environment, and a method for deploying and executing the deployment specification on a system in a mixed environment. The deployment specification may include a total of four detailed specifications, that is, “Global Information” 1010, “Basic Information” 1020, “System Information” 1030, and “Application Information” 1040. The detailed specification “Global Information” influences the entire detailed specification, as shown in reference numeral 1050.

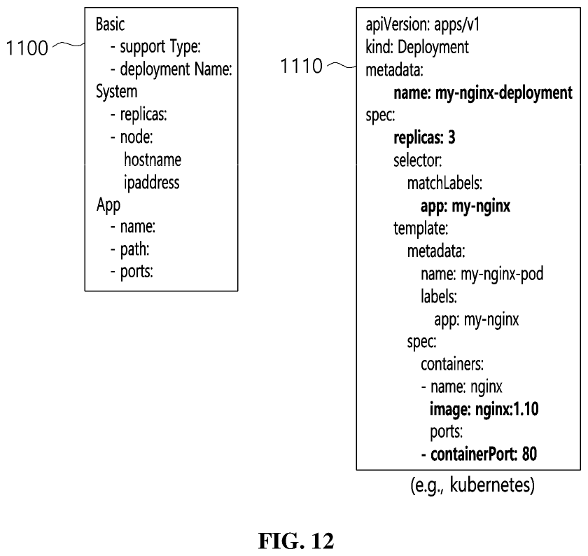

FIG. 12 illustrates an example of a deployment specification in a method according to an embodiment of the present disclosure.

In the “type” field of “Global information” in section 1100 of FIG. 12, a real-world deployment and execution method, a virtual-world deployment and execution method, and a mixed-reality deployment and execution method are specified. The specification “Basic Information” specifies a support type and a deployment name in the section 1110 of FIG. 12, and the specification “System Information” specifies information about the number of replicas to be used and information about a node on which the application is to be executed in the section 1110 of FIG. 12. The information about the node on which the application is to be executed is provided by the knowledge sharing system. Further, the specification “Application Information” specifies the name of an application to be executed, the location of the application, service ports, etc. in the section 1110 of FIG. 12. This application is also provided by the knowledge sharing system. Unless the knowledge sharing system provides desired information, the user needs to personally specify the corresponding information. The section 1110 of FIG. 12 shows the specification executed on Kubernetes.

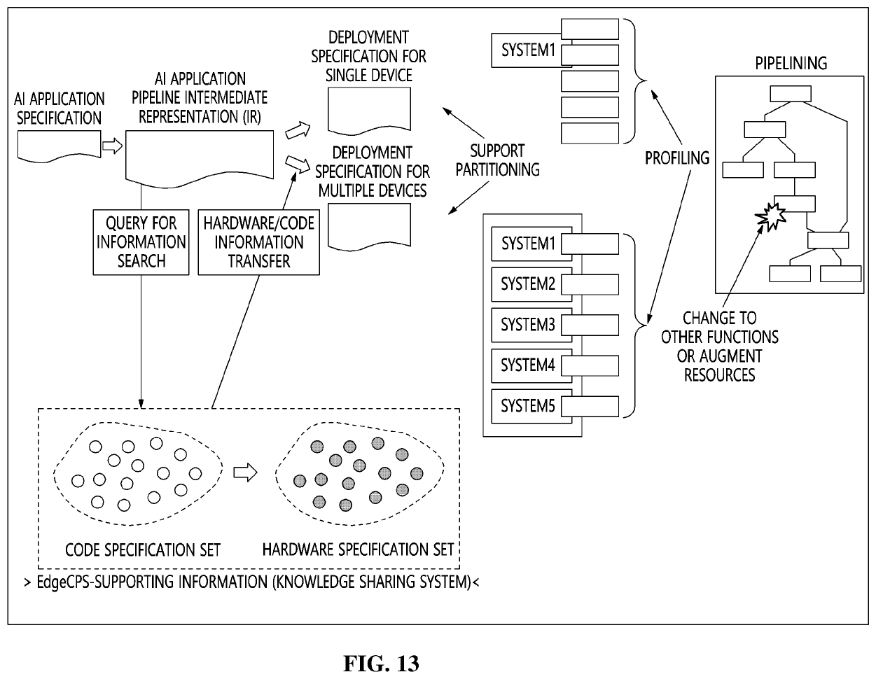

FIG. 13 is a diagram conceptually illustrating a system for providing an artificial intelligence application according to an embodiment of the present disclosure.

Referring to FIG. 13, based on information-sharing technology for supporting EdgeCPS, the application is executed on a system in the real environment, a system in a virtual environment, and a system in a mixed environment through specifications for deployment for a single device and deployment for multiple devices based on AI application SW specifications. Further, deployment for a single device and deployment for multiple devices may internally support partitioning. That is, a function composed of one feature may be partitioned into multiple features. Profiling is performed on functions running on each system while this process is performed. Problematic portions are searched for while the functions are profiled, and problems may be solved by changing the corresponding portions to other functions or augmenting resources.

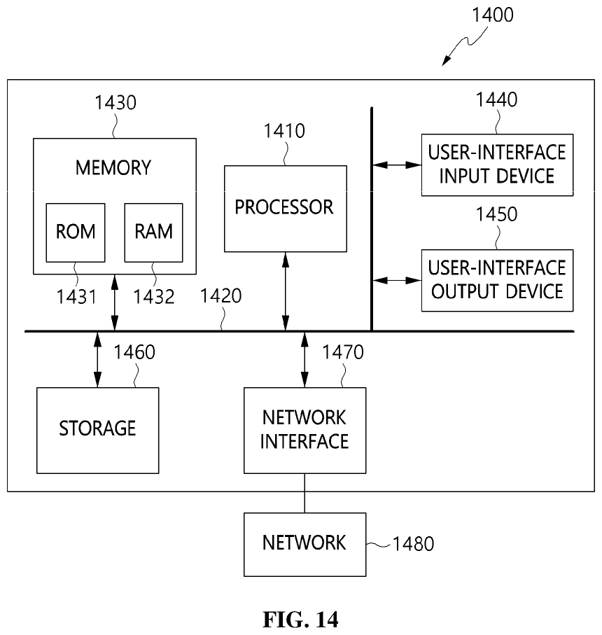

FIG. 14 is a diagram illustrating the configuration of a computer system according to an embodiment.

An artificial intelligence application provision apparatus for supporting EdgeCPS according to an embodiment may be implemented in a computer system 1400 such as a computer-readable storage medium.

The computer system 1400 may include one or more processors 1410, memory 1430, a user interface input device 1440, a user interface output device 1450, and storage 1460, which communicate with each other through a bus 1420. The computer system 1400 may further include a network interface 1470 connected to a network 1480. Each processor 1410 may be a Central Processing Unit (CPU) or a semiconductor device for executing programs or processing instructions stored in the memory 1430 or the storage 1460. Each of the memory 1430 and the storage 1460 may be a storage medium including at least one of a volatile medium, a nonvolatile medium, a removable medium, a non-removable medium, a communication medium, an information delivery medium or a combination thereof. For example, the memory 1430 may include Read-Only Memory (ROM) 1431 or Random Access Memory (RAM) 1432.

An artificial intelligence application provision apparatus for supporting EdgeCPS according to an embodiment of the present disclosure includes memory 1430 configured to store at least one program and a processor 1410 configured to execute the program, wherein the program includes instructions for performing the step of receiving an artificial intelligence (AI) application and service specification, the step of obtaining AI-related information allocated from an AI information sharing database based on the AI application and service specification, the step of creating a pipeline specification corresponding to the AI application and service specification, and the step of allocating resources corresponding to respective pipelines using the pipeline specification.

Here, the step of allocating the resources corresponding to respective pipelines may include the step of allocating the resources using a deployment specification created based on a query converter.

Here, the query converter may create a query for extracting the AI-related information from the AI information sharing database based on the AI application and service specification.

Here, the deployment specification may include detailed specifications including global information, basic information, system information, and application information, and the global information includes information applied to remaining detailed specifications.

Here, the program may further include instructions for performing the step of, when the resources allocated to the pipelines are insufficient, transmitting a request to allocate additional resources to an AI resource information system, and the step of rebuilding the pipelines based on the additionally allocated resources.

Here, the AI application and service specification may include information about an AI application category, an AI application deployment way, an AI application type, an AI application inference method, an AI application inference type, or an AI application inference target.

Here, the pipeline specification includes input/output of the AI application, preprocessed information, a number of parameters, or characteristic information of the AI application.

Specific executions described in the present disclosure are embodiments, and the scope of the present disclosure is not limited to specific methods. For simplicity of the specification, descriptions of conventional electronic components, control systems, software, and other functional aspects of the systems may be omitted. As examples of connections of lines or connecting elements between the components illustrated in the drawings, functional connections and/or circuit connections are exemplified, and in actual devices, those connections may be replaced with other connections, or may be represented by additional functional connections, physical connections or circuit connections. Furthermore, unless definitely defined using the term “essential”, “significantly” or the like, the corresponding component may not be an essential component required in order to apply the present disclosure.

According to the present disclosure, there can be provided an optimal execution environment for an application service in an artificial intelligence application software specification platform in an EdgeCPS environment.

Further, the present disclosure may provide a function that allows a program developer or a user to easily develop an artificial intelligence application in an EdgeCPS environment.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. An artificial intelligence application provision method for supporting Edge computing for Cyber-Physical Systems (EdgeCPS), comprising:
receiving an artificial intelligence application and service specification;
obtaining artificial intelligence-related information allocated from an artificial intelligence information sharing database based on the artificial intelligence application and service specification;
creating a pipeline specification corresponding to the artificial intelligence application and service specification; and
allocating resources corresponding to respective pipelines using the pipeline specification.

2. The artificial intelligence application provision method of claim 1, wherein allocating the resources corresponding to respective pipelines comprises:
allocating the resources using a deployment specification created based on a query converter.

3. The artificial intelligence application provision method of claim 2, wherein the query converter creates a query for extracting the artificial intelligence-related information from the artificial intelligence information sharing database based on the artificial intelligence application and service specification.

4. The artificial intelligence application provision method of claim 2, wherein the deployment specification includes detailed specifications including global information, basic information, system information, and application information, and the global information includes information applied to remaining detailed specifications.

5. The artificial intelligence application provision method of claim 1, further comprising:
when the resources allocated to the pipelines are insufficient, transmitting a request to allocate additional resources to an artificial intelligence resource information system; and
rebuilding the pipelines based on the additionally allocated resources.

6. The artificial intelligence application provision method of claim 1, wherein the artificial intelligence application and service specification includes information about an artificial intelligence application category, an artificial intelligence application deployment way, an artificial intelligence application type, an artificial intelligence application inference method, an artificial intelligence application inference type, or an artificial intelligence application inference target.

7. The artificial intelligence application provision method of claim 1, wherein the pipeline specification includes input/output of the artificial intelligence application, preprocessed information, a number of parameters, or characteristic information of the artificial intelligence application.

8. An artificial intelligence application provision apparatus for supporting Edge computing for Cyber-Physical Systems (EdgeCPS), comprising:
a memory configured to store at least one program; and
a processor configured to execute the program,
wherein the program comprises instructions for performing:
receiving an artificial intelligence application and service specification;
obtaining artificial intelligence-related information allocated from an artificial intelligence information sharing database based on the artificial intelligence application and service specification;
creating a pipeline specification corresponding to the artificial intelligence application and service specification; and
allocating resources corresponding to respective pipelines using the pipeline specification.

9. The artificial intelligence application provision apparatus of claim 8, wherein allocating the resources corresponding to respective pipelines comprises:
allocating the resources using a deployment specification created based on a query converter.

10. The artificial intelligence application provision apparatus of claim 9, wherein the query converter creates a query for extracting the artificial intelligence-related information from the artificial intelligence information sharing database based on the artificial intelligence application and service specification.

11. The artificial intelligence application provision apparatus of claim 9, wherein the deployment specification includes detailed specifications including global information, basic information, system information, and application information, and the global information includes information applied to remaining detailed specifications.

12. The artificial intelligence application provision apparatus of claim 8, wherein the program further comprises instructions for performing:
when the resources allocated to the pipelines are insufficient, transmitting a request to allocate additional resources to an artificial intelligence resource information system; and
rebuilding the pipelines based on the additionally allocated resources.

13. The artificial intelligence application provision apparatus of claim 8, wherein the artificial intelligence application and service specification includes information about an artificial intelligence application category, an artificial intelligence application deployment way, an artificial intelligence application type, an artificial intelligence application inference method, an artificial intelligence application inference type, or an artificial intelligence application inference target.

14. The artificial intelligence application provision apparatus of claim 8 wherein the pipeline specification includes input/output of the artificial intelligence application, preprocessed information, a number of parameters, or characteristic information of the artificial intelligence application.
